(19) United States
(12) Patent Application Publication
(10) Pub. No.: US 2016/0261712 A1
(43) Pub. Date: Sep. 8, 2016

(54) METHODS AND SYSTEMS FOR REQUESTING ACCESS TO LIMITED SERVICE INSTANCES

(71) Applicant: Calgary Scientific Inc., Calgary (CA)

(72) Inventor: Kevin Edward Matte, Calgary (CA)

(21) Appl. No.: 15/060,022

(22) Filed: Mar. 3, 2016

Related U.S. Application Data
(60) Provisional application No. 62/127,449, filed on Mar. 3, 2015.

(51) Int. Cl. H04L 29/08; H04L 29/06

(52) U.S. Cl. CPC H04L 67/32; H04L 67/42; H04L 67/16; H04L 63/10

(57) ABSTRACT

Systems and methods for requesting termination of a service instance that is owned by a client computing device when, for example, there is limited availability of such service instances. In accordance with an aspect of the disclosure, a method for requesting termination of a service instance executing on a remote application server, the service instance being owner by a first client device, is described. The method may include receiving, at a second client device, a list of service instances to which a request may be made, the list of service instances including the service instance; requesting, by the second client device, termination of the service instance; forwarding a request to the first client device to terminate the service instance; and creating a new service instance if the service instance is terminated whereafter the second client device becomes the owner of the newly created service instance.

### CROSS-REFERENCED TO RELATED APPLICATION

This application claims priority to U.S. Provisional Patent Application No. 62/127,449, filed Mar. 3, 2015, entitled “Methods and Systems for Requesting Access to Limited Service Instances,” which is incorporated herein by reference in its entirety.

### BACKGROUND

Ubiquitous remote access to service instances has become commonplace as a result of the growth and availability of broadband and wireless network access. As such, users are accessing service instances using an ever-growing variety of client devices (e.g., mobile devices, tablet computing devices, laptop/notebook/desktop computers, etc.). The service instances may be accessed over a remote server that may communicate messages that contain data or other information between service instances and client devices over a variety of networks including, 3G and 4G mobile data networks, wireless networks such as WiFi and WiMax, wired networks, etc.

There may be a limited number of service instances available at any given time due to resource or physical constraints. As such, clients attempting to connect to service instances may be unable to do so. This may cause a problem for a client that needs to access a service that is in-use by another client or in an idle waiting state after a client has established communications.

### SUMMARY

Disclosed herein are systems and methods for requesting termination of a service instance that is owned by a client computing device when, for example, there is limited availability of such service instances. In accordance with an aspect of the disclosure, a method for requesting termination of a service instance executing on a remote application server, the service instance being owned by a first client device, is described. The method may include receiving, at a second client device, a list of service instances to which a request may be made, the list of service instances including the service instance; requesting, by the second client device, termination of the service instance; forwarding a request to the first client device to terminate the service instance; and creating a new service instance if the service instance owned by the first client device is terminated whereafter the second client device becomes the owner of the new service instance.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a simplified block diagram illustrating an environment for providing access to limited service instances;

FIG. 2 is an example operational flow for providing and requesting access to limited service instances;

FIGS. 3A-3B are simplified block diagrams illustrating an example of providing access to limited service instances in accordance with the operational flow of FIG. 2 within the environment of FIG. 1;

FIGS. 4-6 illustrate example user interfaces associated with the operational flow of FIG. 2;

FIG. 7 is a simplified block diagram illustrating another example environment for providing access to limited service instances; and

FIG. 8 illustrates an exemplary computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure.

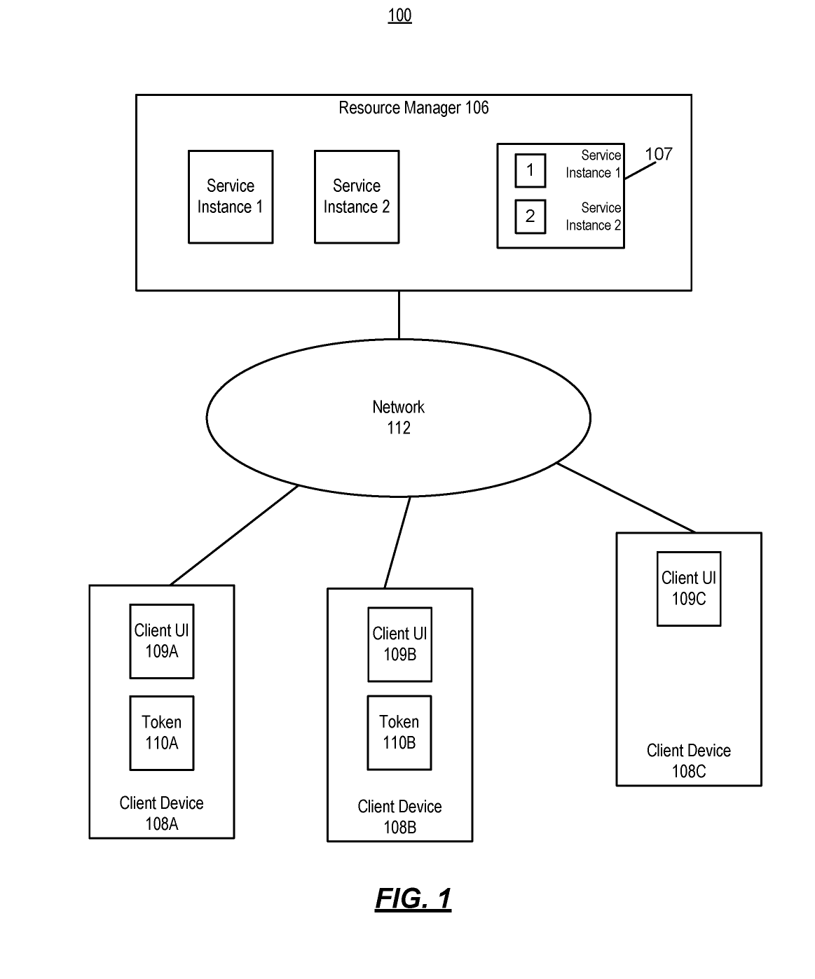

FIG. 1 is a simplified block diagram illustrating an environment 100 for providing access to limited service instances. In accordance with some implementations, one or more service instances 1/2 may be provided, which may be, applications, data providers, etc. that are remotely accessed by client devices 108A/108B/108C. The service instances 1/2 may be executed on application servers (not shown) that each may run multiple service instances as resources permit. Users of the client devices 108A/108B/108C may enter a predetermined connection Uniform Resource Locator (URL) in a client user interface (UI) 109A/109B/109C to connect to the service instances 1/2 through a resource manager 106 over a communications network 112. The network 112 may be any type of network, for example, the Internet, Ethernet, Wi-Fi (IEEE 802.11x), WiMax (IEEE 802.16), Ethernet, 3G, 4G, LTE, etc.

As used herein, when a client device is connected to a particular service instance, its respective client UI is a “host” or “owner” that holds the service instance. For example, if the client device 108A is connected the service instance 1, the client UI 109A “hosts” or “owns” the service instance 1. The client devices 108A/108B/108C, when their respective client UI 109A/109B/109C acts as a host or owner, may be provided with a token 110A/110B that represents ownership of a slot for a running service instance. The token 110A/110B be any identifier of the slot which represents a running service instance. For example, the token 110A/110B may be an instanceId. In accordance with other aspects of the present disclosure, the token may be maintained by either the owner client device 108A/108B/108C, the resource manager 106 or both. The token 110A/110B may be created when an associated service instance starts-up, when a client device connects to the service instance, or at another time.

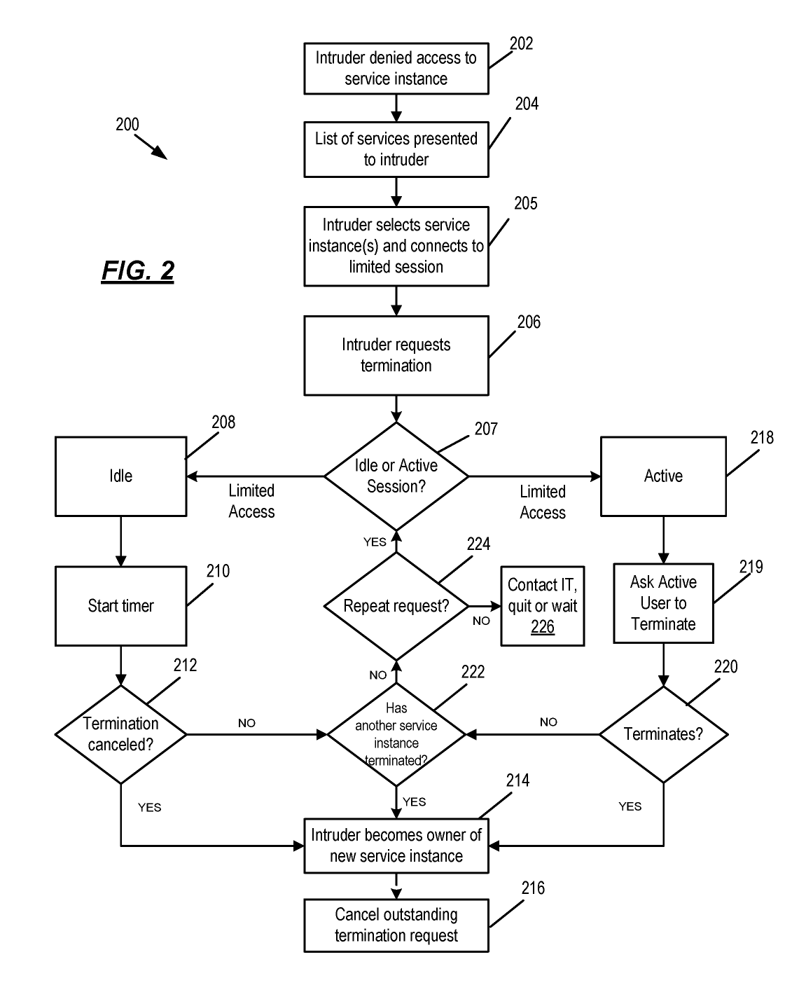

The resource manager 106 is provided with a mechanism to enable a client device 108A/108B/108C to request termination of a service instance when no service instances are available. The resource manager 106 may maintain a list of service instances 107 that are registered therewith (as described below). The list may include information about each of the service instances, such as, but is not limited to, the token associated with the service instance, host information (e.g. username, full name, department, etc.), and post-session information (e.g., status of session, idle/non-idle state, etc.). The idle time is a period of time when a user does not interact with the service instance. Further details of the resource manager 106 will be described below with reference to FIG. 2.

The resource manager 106 may be executing on a same or different server than the service instances 1/2. The service instances 1/2 may connect to the resource manager 106 at a predetermined Internet Protocol (IP) address and/or socket or using a URL associated with the resource manager 106 to register itself with the resource manager 106. In some instances, the service instances 1/2 may connect to the resource manager 106 over the network 112 to register with the resource manager 106. Once registered, the service instance 1/2 is queued such that a client device may connect therewith. Queued service instances may be referenced by a unique instanceId. The client device may connect to the service instance by connecting to the resource manager 106 and may either connect to a specific service instance of the queued service by using the application instanceId or connect to the first available queued service instance of a particular type using the application name.

The service instance 1/2 may be an “unmanaged service,” which is a service that may reside on a same or different server (node) than a server (node) of the resource manager 106. In unmanaged services, the application/process life cycle is not managed by the resource manager 106.

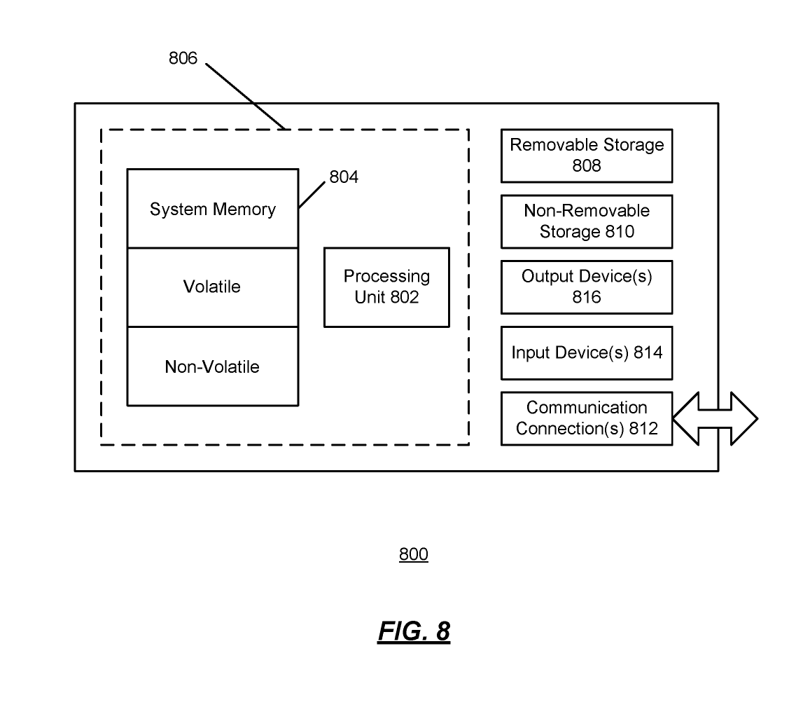

The servers and client devices 108A/108B/108C described above may be implemented using hardware such as that shown in the general purpose computing device of FIG. 8. Software, applications (e.g., the service instance 1/2, the resource manager 106, and the client UI 109A/109B/109C) operating systems, etc. may be executed in memory and on the processer of the general purpose computing device of FIG. 8.

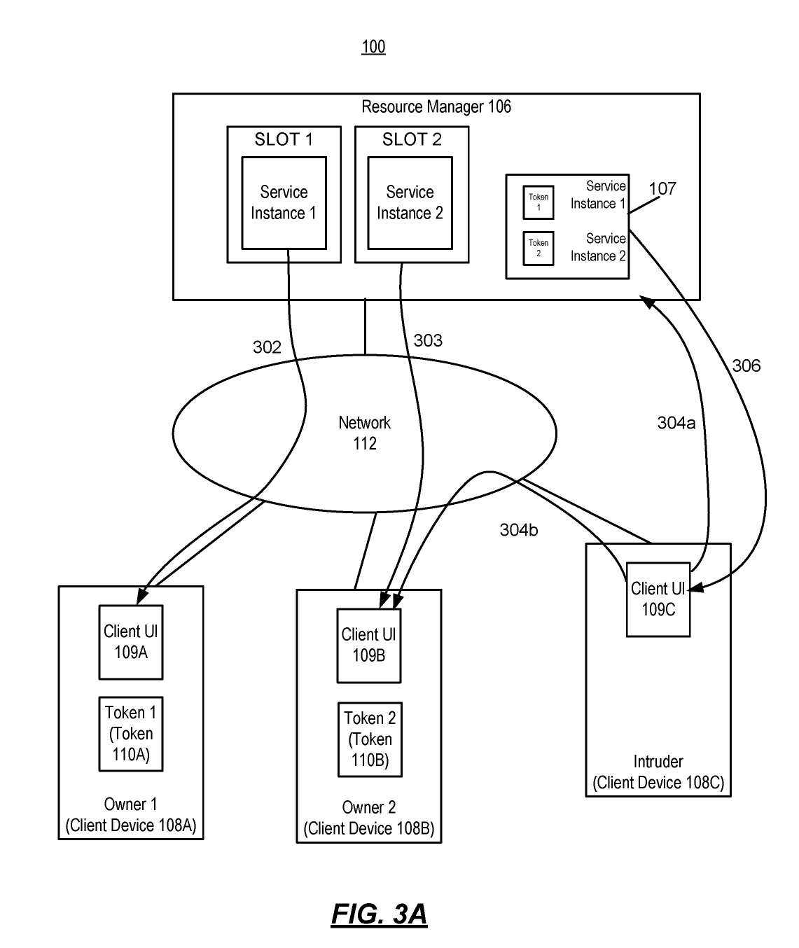

FIG. 2 is an example operational flow 200 for providing and requesting access to limited service instances that may be implemented in environment 100. FIGS. 3A-3B illustrate connectivities and data flow in the environment 100 in accordance with the operational flow 200. Initially, as shown in FIG. 3A, the client device 108A is Owner 1, which owns Service Instance 1 in Slot 1. Service Instance 1 is displayed in the client UI 109A (see, connection 302). Therefore, Owner 1 is provided with Token 1. Client device 108B is Owner 2 and owns Service Instance 2 in Slot 2. Service Instance 2 is displayed in the client UI 109B (see, connection 303). As such, Owner 2 is provided with Token 2.

At 202, an “intruder” may request access to a new service instance; however, the intruder is denied access. As used herein, the client device (e.g., 108C) requesting termination of one or more service instances is called an “intruder.” For example, the intruder—client device 108C—may make a request to the resource manager 106 to access a new service instance, but is denied as there may be no resource available for a new service instance (see, reference numeral 304a).

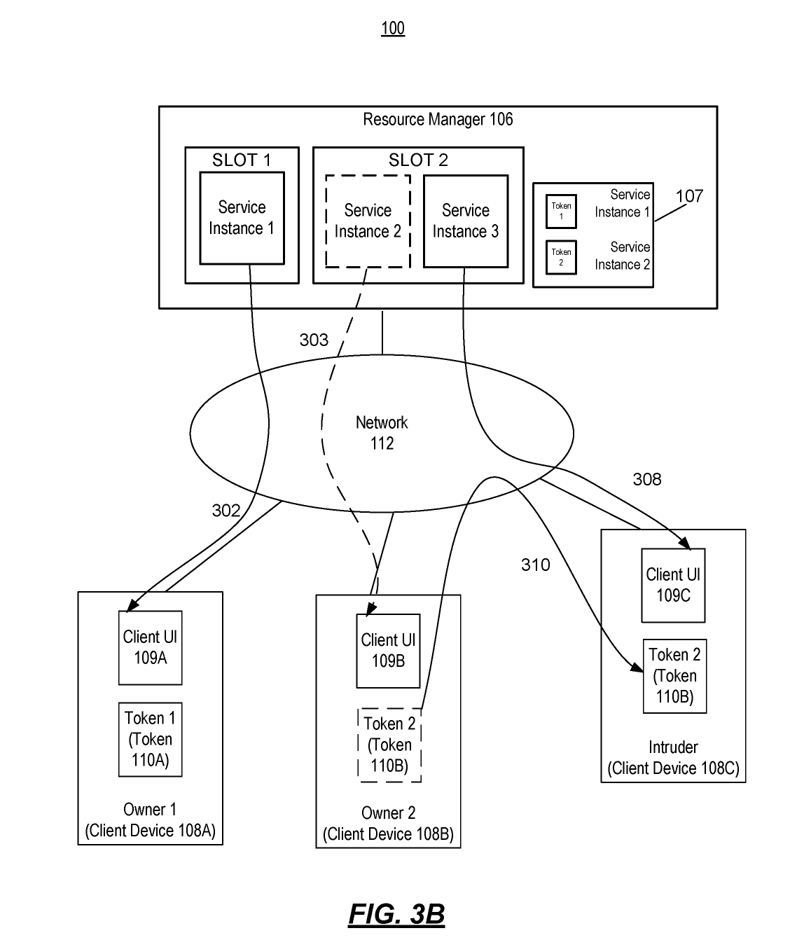

At 204, the intruder is presented with a list of service instances. For example, the intruder may be authenticated by the resource manager 106 and presented a table or the list of service instances 107 to which the intruder may request termination of (see, reference numeral 306). An example user interface showing the list of services is shown in FIG. 4.

The list of service instances may be sorted or prioritized in accordance with a level access or authority assigned to the intruder, an importance of the particular service instance, resources available at the application server on which the service instance executes, or other criteria. The information provided to the intruder at 204 may also be sorted according to pre-configured rules, e.g., the access/authority level (e.g., a user will not see instances associated with other users having higher levels of authority or access), idle time, department, position, user preferences, etc., or manually sorted by the intruder. The list of service instances may include service instances and their respective tokens (e.g., Token 1, Token 2, etc.).

At 205, the intruder selects a service instance (or instances) from the list of service instances 107. As shown in FIG. 4, the intruder may request termination of Service Instance 2 by clicking a checkbox. A limited access connection may be established that connects the intruder to the session, however the intruder does not collaboratively participate in the session, nor is the intruder visible to other client devices in the session. The resource manager 106 may also hold Slot 2 for the intruder so no other intruder or user may connect to a service instance ahead of the intruder.

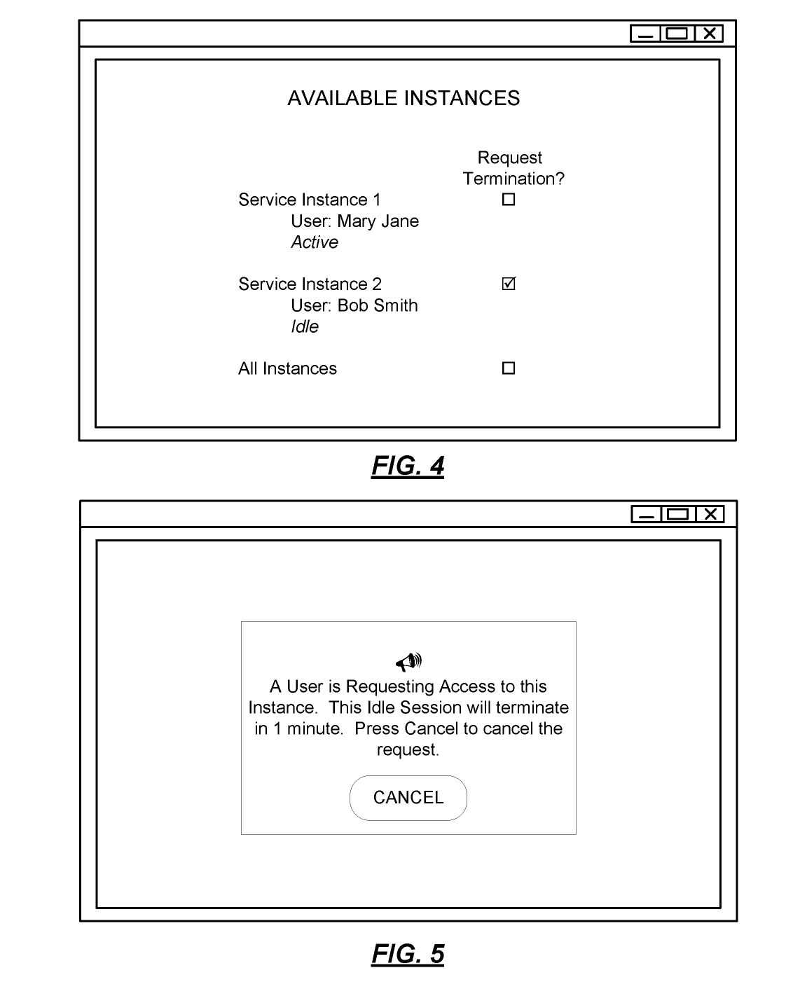

At 206, the intruder may request termination of one or more service instances. For example, in the dialog box of FIG. 4, the user at the intruder has selected a service instance to request termination (e.g., Service Instance 2 owned by Owner 2). Using an inter-client communication mechanism provided by the environment 100, the intruder contacts the client devices of sessions associated with the service instances to which the intruder is requesting termination. At 207, it is determined if the requested service instance(s) for termination is idle or active. If the service instance is idle (i.e., one where a user is not actively interacting therewith), then at 208, the idle service instance and/or client device may listen for an intruder and a timer is started (at 210) to provide an option for the client device (or a user interacting with the client device) to cancel the termination request. For example, the user interface of FIG. 5 may be presented in the client UI displaying the idle service instance to provide a warning and option for a user at the client device to cancel the request. In some implementations, a one minute timer may be set to enable the client device or user to cancel the request. Alternatively, the user interface of FIG. 5 may display the user name of the intruder. At 212, it is determined if the client device or user at the client device has canceled the termination request.

If the client device or user did not cancel the termination, then at 214 the intruder becomes the owner of a new service instance created in the place of the terminated service instance. For example, as shown in FIG. 3B, when Service Instance 2 in Slot 2 owned by Owner 2 terminates, the connection 303 is terminated, and a new Service Instance 3 is created in Slot 2. A new connection 308 is created between the intruder and Service Instance 3, which is now executing in Slot 2. The intruder now becomes the owner of Service Instance 3 and Token 2 is passed to the intruder (see, flow 310). Optionally at 216, any outstanding termination requests associated with the intruder are canceled, as the intruder may have requested termination of more than one service instance at 206.

However, if at 212, the host cancels the termination, then at 222 it is determined if another service instance is terminated. If so, then at 214 the intruder becomes owner of the new service instance created in place of the recently terminated service instance, as noted above. Again, optionally at 216, any outstanding termination requests associated with the intruder are canceled. However, if at 222, no other service instances have terminated, then at 224 it is determined if the request should be repeated. If so, the process returns to 206. If not, then the process proceeds to 226 where a request may be made to Information Technology (IT) support for more assistance, the process may end, or the intruder may wait for a session to become available.

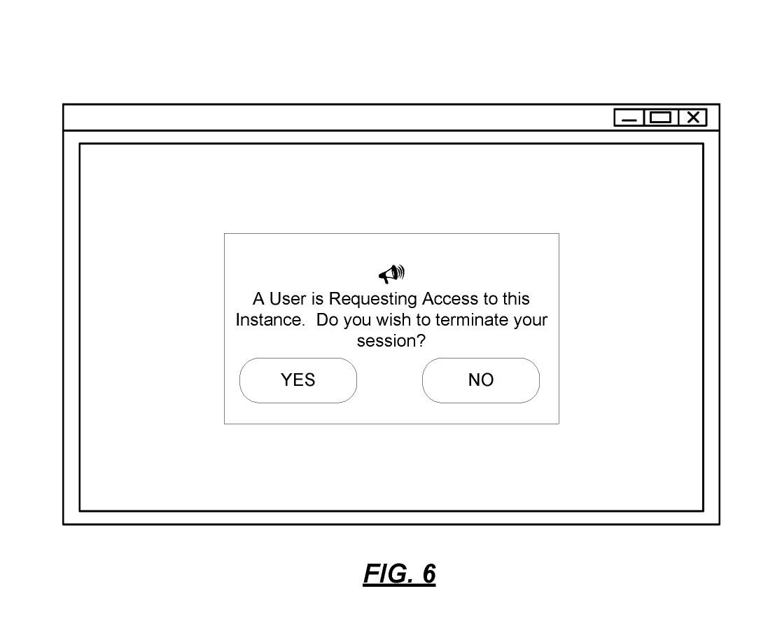

Returning to 207, if it is determined that the intruder has requested termination of an active service instance (at 218), then at 219, a user at the client device is asked to terminate. For example, if Owner 2 was associated with the active service request, a user at Owner 2 would be presented a user interface in client UI 109B, such as shown in FIG. 6. Alternatively, the user interface of FIG. 6 may display the user name of the intruder. Next, at 220, it is determined if the user at the client device has in-fact terminated in response to the request. In accordance with aspects of the disclosure, an active service instance must be explicitly terminated in response to the intruder's request. If the service instance has terminated, then the flow continues at 214, as described above. However, if at 220 the service instance has not terminated, then at 222 it is determined if another service instance has terminated. If so, then at 214 the flow continues as described above. However, if at 222 no other service instance has terminated then the process at 224 and 226 are performed as discussed above.

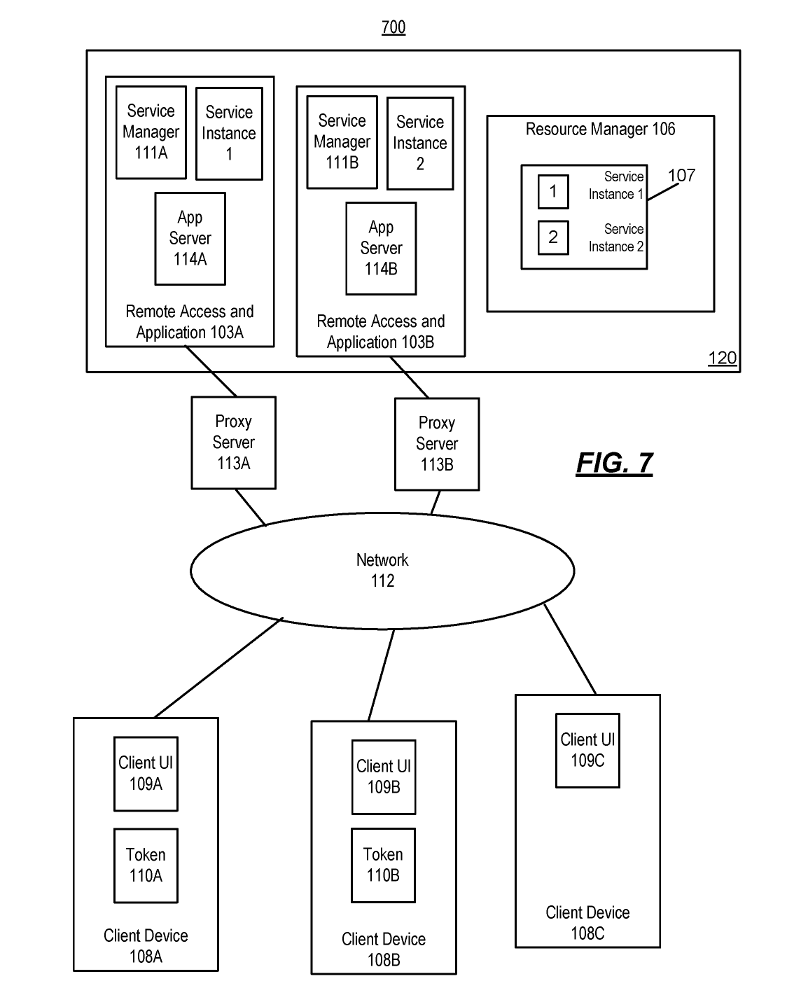

FIG. 7 is a simplified block diagram illustrating another environment 700 for providing access to limited service instances. The environment 700 may be provided as a scalable, fault tolerant remote access architecture in, e.g., a cloud infrastructure such as Amazon Web Services (AWS) or other entities. While the environment 700 is intended to scale to accommodate potentially large numbers of service instances and Hosts, there may be other limitations on scalability, such as licensing constraints, physical capacity, network capacity, etc. As such, the techniques of the present disclosure may be implemented to provide access to service instances to intruders.

In FIG. 7, remote access and application servers 103A/103B may be provided to host service instance 1 and service instance 2, respectively. Although only one service instance is shown on each of the remote access and application servers 103A/103B, there may be more than one service instance executing on each of the remote access and application servers 103A/103B. The remote access and application servers 103A/103B may be cloud-based instances that are created from images. For example, there may be a pre-built image associated with each service instance such that the image can be loaded onto a remote access and application server 103A/103B when instantiated in a cloud environment.

Each remote access and application server 103A/103B may include a service manager 111A/111B and an application server 114A/114B. The service manager 111A/111B is responsible for stopping and starting service instances on a particular remote access and application server 103A/103B. The application server 114A/114B provides for connection marshalling and may include a server SDK (not shown) that provides display information to the service instances 1/2 from the client device 108A/108B/108C and vice versa. An example of the remote access and application server 103A/103B is PUREWEB, available from Calgary Scientific, Inc. of Calgary, Alberta, Canada.

Proxy servers 113A/113B may be an HTTP server and reverse proxy server capable of handling a relatively large number of simultaneous requests. As shown, the proxy server 113A/113B executes on a node (e.g., a server computing device) separate from the remote access and application server(s) 103A/103B. An example proxy server 113A/113B is nginx, available from Nginx Inc., San Francisco, Calif.

The resource manager 106 may be provided as a functionality of a scheduler (not shown) that may manage the utilization of resources, such as remote access and application servers 103A/103B or other nodes within a cluster 120. In addition to the functions of the resource manager 106, the scheduler may implement one or more selection heuristics to determine which application server 103A/103B to service a remote access connection request, as described in U.S. patent application Ser. No. 15/011,183.

The example operational flow 200 of FIG. 2 for providing and requesting access to limited service instances that may also be implemented in environment 700. However, due to the nature of the environment 700, a difference in the connectivities and data flow of FIGS. 3A-3B is that the Hosts (i.e., client devices 108A/108B/108C) connect to the proxy servers 113A/113B, which provide connections to service instance 1/2, respectively.

In accordance with aspects of the present disclosure, there may be multiple intruders requesting access to service instances. Each of the requests made by the multiple intruders may be prioritized based on a first-in-first-out basis, an urgency of the need of the request, a level of authority of the requester, etc. Further, it is noted that the above may mitigate limited service instance availability that results from an enterprise system with limited resources, e.g., limited number of licenses, limited CPU/GPU capability, etc. The techniques described herein may also be used in cloud-based environments.

As an example, the above techniques may be used by an emergency room physician that requires immediate access to a medical imaging application. In another example, a high ranking military office may have precedence over lower ranking personnel to access to a logistical application showing troop or equipment deployments. In yet another example, a manager may be provided precedence over a subordinate to gain access to a business application. Thus, the techniques disclosed herein may be used in many different environments to provide access to a service where instances are limited by constraints such as physical capacity, logical capacity, licensing, etc.

FIG. 8 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing device 800. In its most basic configuration, computing device 800 typically includes at least one processing unit 802 and memory 804. Depending on the exact configuration and type of computing device, memory 804 may be volatile (such as random access memory (RAM)), non-volatile (such as read-only memory (ROM), flash memory, etc.), or some combination of the two. This most basic configuration is illustrated in FIG. 8 by dashed line 806.

Computing device 800 may have additional features/functionality. For example, computing device 800 may include additional storage (removable and/or non-removable) including, but not limited to, magnetic or optical disks or tape. Such additional storage is illustrated in FIG. 8 by removable storage 808 and non-removable storage 810.

Computing device 800 typically includes a variety of computer readable media. Computer readable media can be any available media that can be accessed by device 800 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 804, removable storage 808, and non-removable storage 810 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of computing device 800.

Computing device 800 may contain communications connection(s) 812 that allow the device to communicate with other devices. Computing device 800 may also have input device(s) 814 such as a keyboard, mouse, pen, voice input device, touch input device, etc. Output device(s) 816 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for requesting termination of a service instance, the service instance being owned by a first client device, comprising:
receiving, at a second client device, a list of service instances to which a request may be made, the list of service instances including the service instance;
requesting, by the second client device, termination of the service instance owned by the first client device;
forwarding a request to the first client device to terminate the service instance; and
creating a new service instance if the service instance owned by the first client device is terminated whereafter the second client device becomes the owner of the new service instance.

2. The method of claim 1, further comprising receiving the list of service instances after a denial of access received by the second client device.

3. The method of claim 1, further comprising requesting termination using a token that provides access to a session owned by the first client device.

4. The method of claim 1, further comprising sorting the list of service instances in accordance with one of a level access associated with an intruder at the second client device, an importance of the service instance, resources available at a remote application server on which the service instance executes, an idle time of each service instance in the list of service instances.

5. The method of claim 1, forwarding the request to terminate at least one of the service instances further comprising:
presenting a dialog box to an intruder at the second client device to select the service instance;
determining if the service instance is idle; and
if so, starting a timer to provide a predetermined period of time during which the first client device can cancel the request to terminate.

6. The method of claim 5, further comprising canceling outstanding termination requests.

7. The method of claim 5, wherein the predetermined period of time is configurable.

8. The method of claim 7, wherein the predetermined period of time is one minute.

9. The method of claim 1, forwarding the request to terminate at least one of the service instances further comprising:
determining if an intruder at the second client device has requested termination of an active service instance; and
determining if the active service instance has terminated in response to the request.

10. The method of claim 9, further comprising canceling any other outstanding termination requests.

11. A method for requesting access to a service instance, comprising:
receiving a request from a first client device to connect to a service instance within an environment;
denying the request to connect to the service instance due to an unavailability of resources within the environment;
presenting a list of active and/or idle service instances to the first client device;
receiving a request to terminate at least one of the active and/or idle service instances;
forwarding the request to terminate to a second client device that owns the at least one of the active and/or idle service instances; and
assuming ownership of a new service instances by the first client device after the at least one of the active and/or idle service instances is terminated at the second client device.

12. The method of claim 11, forwarding the request to terminate comprising using a token

13. The method of claim 11, wherein if the least one of the active and/or idle service instances is idle, starting a timer to provide a predetermined period of time during which the first client device can cancel the request to terminate.

14. The method of claim 13, further comprising presenting a user interface to allow a user at the first client device to cancel the request

15. The method of claim 11, wherein if the least one of the active and/or idle service instances is active, presenting a user interface to allow a user at the first client device to cancel the request.
